(19) United States
(12) Patent Application Publication
(10) Pub. No.: US 2013/0048716 A1
(43) Pub. Date: Feb. 28, 2013

(54) SYSTEMS AND METHODS FOR CARDHOLDER CUSTOMIZATION OF A USER INTERFACE

(71) Applicant: Paolo Gobetti, Mergozzo (IT)

(72) Inventor: Paolo Gobetti, Mergozzo (IT)

(73) Assignee: Honeywell International Inc., Morristown, NJ (US)

(21) Appl. No.: 13/215,452

(22) Filed: Aug. 23, 2011

(51) Int. Cl. G06F 17/30

(52) U.S. Cl. 235/380

(57) ABSTRACT

Systems and methods are provided for a cardholder to customize a user interface of a terminal in an access control or time and attendance system. Methods include receiving user information from a cardholder or from a card and updating at least one terminal characteristic based on received user information.

### FIELD

The present invention relates generally to access control systems and to time and attendance systems. More particularly, the present invention relates to systems and methods for a cardholder to customize a user interface of a terminal in an access control system or time and attendance system.

### BACKGROUND

Many access control systems and time and attendance systems employ user interfaces or terminals, for example, access points or readers, at which a user can swipe or present his card. The card can contain information about the user and, when presented to the terminal, can transmit that information to the terminal. For example, the card can contain an RF chip, magnetic strip, or the like, that transmits information when in close proximity to an RF reader or the like.

When the card transmits information embedded therein to the terminal, the terminal, connected to the access control system or time and attendance system, can take some action. For example, in an access control system, the terminal can allow or disallow the user access to, for example, a secure area, based on the information in or on the user's card. In a time and attendance system, the terminal can update a database to reflect the time at which the user is coming to or leaving a building.

However, known terminals associated with access control systems and time and attendance systems have limitations. For example, while the terminal can contain a display, some users have specific needs or preferences for viewing or using a terminal display. There is no known system or method to automatically customize the terminal display based on upon a particular user of the terminal.

There is thus a continuing, ongoing need for systems and methods for a cardholder to customize a user interface of a terminal in an access control system or time and attendance system. Preferably, the terminal can be customized based upon the needs or preferences of the user and can be customized in different manners for different users or groups of users.

### BRIEF DESCRIPTION OF THE DRAWINGS

FIG. 1 is a flow diagram of a first method in accordance with the present invention;

FIG. 2 is a flow diagram of a second method in accordance with the present invention; and

FIG. 3 is a block diagram of a system for carrying out the method of FIG. 1, FIG. 2, and others in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods for a cardholder to customize a user interface of a terminal in an access control system or time and attendance system. Preferably, the terminal can be customized based upon the needs or preferences of the user and can be customized in different manners for different users or groups of users.

In accordance with the present invention, when the terminal is customized, the overall usability of an associated access control system or time and attendance system is increased. This is because the terminal functions as the interface between a user and the respective system.

For example, the terminal in an access control system allows a user to register with the system and/or present his credentials to the system to gain access to a secured area. Similarly, the terminal in a time and attendance system allows a user to check in or out with the system.

In accordance with the present invention, a customizable terminal can provide a user with a clear, comfortable, and intuitive environment. In some embodiments, the terminal can be customized to meet the needs of users with disabilities, for example, low vision, color blindness, deafness, or the need for a wheelchair. In other embodiments, the terminal can be customized to meet the needs of users that speak different languages or have different date, time, or currency formats.

Systems and methods in accordance with the present invention can automatically change the display appearance or behavior of a terminal associated with an access control system or time and attendance system. The changes can be made based on the identification of a user, for example, a cardholder. In some embodiments, of the present invention, a user or a card presented by the user can transmit an explicit request to the terminal to customize the terminal. In some embodiments, information about the user/cardholder that is transmitted to the terminal can be used by the terminal to customize the terminal's display appearance or to otherwise alter the behavior of the terminal.

In embodiments of the present invention, when a user customizes a first terminal at a first location, a plurality of other terminals associated with the system can be customized in the same manner for the same user. For example, the user can transmit an explicit request to a first terminal to customize the terminal. The user's card can be associated with the user's customization. Then, the first terminal can transmit a message to other terminals in the system regarding the association of the user to the user's customization. Accordingly, when the same user presents his card to any other terminal in the system, the other terminal will reflect the same user customization as the first terminal.

Aspects of the terminal display that can be customized include, but are not limited to the following: colors of the display (i.e., to avoid color combinations not seen by the color blind), contrast of the display, language of the display, size and text of items on the display, volumes of tunes, types of tunes, oral transmission of text shown on the display, emanation of visual cues based on text shown on the display, reduction of operative procedures, extension of time-out periods, operation of particular commands to assist a user in transit (i.e., to open the second half of a door to allow wheelchair access), and the like. For example, different tunes can be customized to signal different events. When oral transmissions are used for text shown on the display, the language of the oral transmission can also be customized based on the user.

In some embodiments of the present invention, the terminal display can also be customized to show information relevant to the cardholder on a particular day. For example, after a user presents his card to the terminal, the terminal display could show the user his agenda or scheduled appointments for the day. In some embodiments, the terminal display can show the cardholder's history of previous interactions with terminals in the system.

In accordance with the present invention, the terminal itself can include control circuitry, a programmable processor, and executable software stored on a non-transitory computer readable medium. Thus, when presented with a card, the terminal can independently customize its own display without instructions from an associated and displaced control unit.

In access control systems, a terminal can facilitate communication between a cardholder and an operator when the cardholder's access has been denied to a particular area. For example, if a cardholder is denied access, the terminal can open a VOIP connection with an operator at the central station or control unit. In this manner, the cardholder can remotely communicate with the operator at the terminal to reach a resolution, if possible.

In some embodiments of the present invention, a first plurality of characteristics of the terminal display can be set to a default mode. The terminal display can be presented with the first plurality of characteristics in default mode unless and until a user and/or a user's card instructs the terminal otherwise. For example, a user's card can include information embedded therein, including user preferences for a second plurality of characteristics of the terminal display. The second plurality of characteristics can be a sub-set of the first plurality of characteristics.

When the information from the card is transmitted to the terminal, the terminal can update the second plurality of characteristics accordingly, for example, the terminal can change each of the second plurality of characteristics to a user-preference mode. In some embodiments, the user preference mode can be the same as the default mode. The remaining characteristics in the first plurality of characteristics that were not in the second plurality of characteristics can stay in the default mode.

For example, the terminal display can be presented in English as the default mode. A first user can possess a first card with an English language preference embedded therein. When the first user presents the first card to the terminal, the terminal can identify that the first user preference language (English) is the same as the default language (English). Thus, the terminal will not change the language of the terminal display.

A second user can possess a second card with an Italian language preference embedded therein. When the second user presents the second card to the terminal, the terminal can identify that the second user preference language (Italian) is different from the default language (English). Thus, the terminal can change the language of the terminal display from English to Italian.

In some embodiments of the present invention, the terminal can include a plurality of input options, for example, buttons, icons, speakers, microphones, or the like, for receiving user input. Using the input options, the user can enter his preferences for customizing the terminal display. In some embodiments, the terminal can include a dedicated button or icon for the user to select if he wishes to customize the terminal. After customization is complete, the user can present his card to the terminal so that the user entered customization can be associated with that user/cardholder/card.

When the terminal changes a characteristic of the terminal display from a default mode to a user preference mode, the terminal display can be shown with the user preference mode for a period of time. For example, the terminal display can be shown with the user preference mode for a predetermined period of time or for a predetermined period of time after the last user interaction with the terminal. In some embodiments, the terminal display can be shown with the user preference mode until a second user presents a card with a different user preference. Thus, in accordance with some embodiments of the present invention, when a terminal changes a characteristic to a user preference mode, the terminal can reset its default mode to the user preference mode.

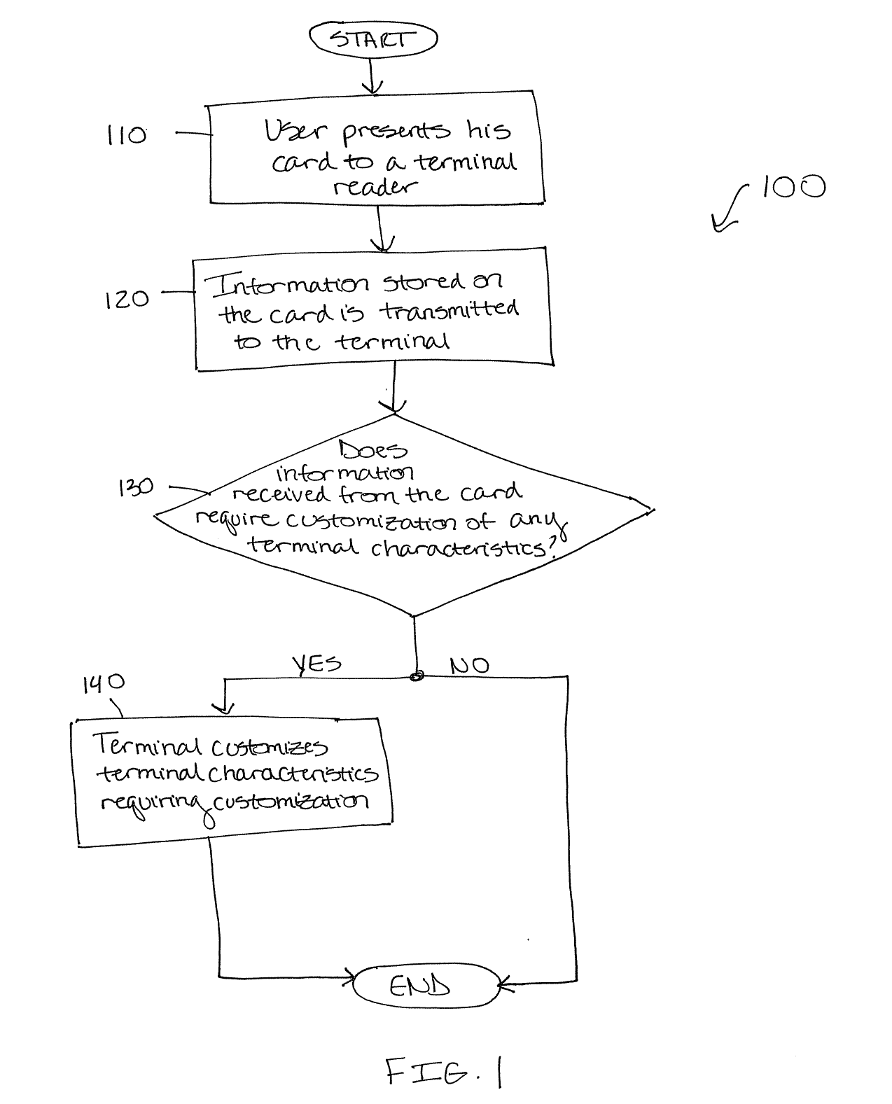

FIG. 1 is a flow diagram of a first method 100 in accordance with the present invention. As seen in FIG. 1, a user can present his card to a terminal reader as in 110. Then, information stored on the card can be transmitted to the terminal as in 120. The terminal can determine if information received from the card requires customization of any terminal characteristics as in 130. If not, the method 100 can terminate.

However, if the terminal determines that information received from the card requires customization of any terminal characteristics as in 130, then the terminal can customize the terminal characteristics requiring customization as in 140.

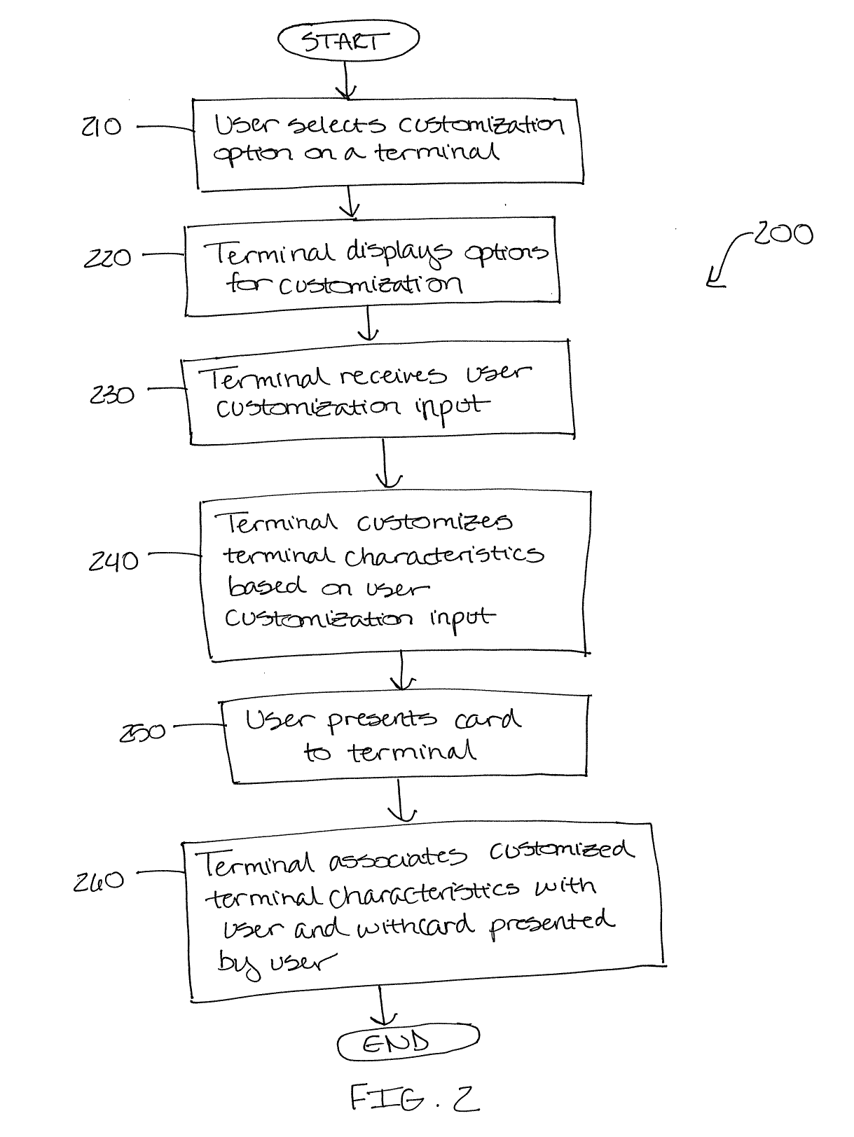

FIG. 2 is a flow diagram of a second method 200 in accordance with the present invention. As seen in FIG. 2, a user can select a customization option on a terminal as in 210. Then, the terminal can display options to the user for customization as in 220. The terminal can receive user customization input as in 230 and customize characteristics based on the user customization input as in 240.

After the terminal has completed user customization as in 240, the user can present his card to the terminal as in 250. Then, the terminal can associate the customized characteristics with the user and with the card presented by the user as in 260.

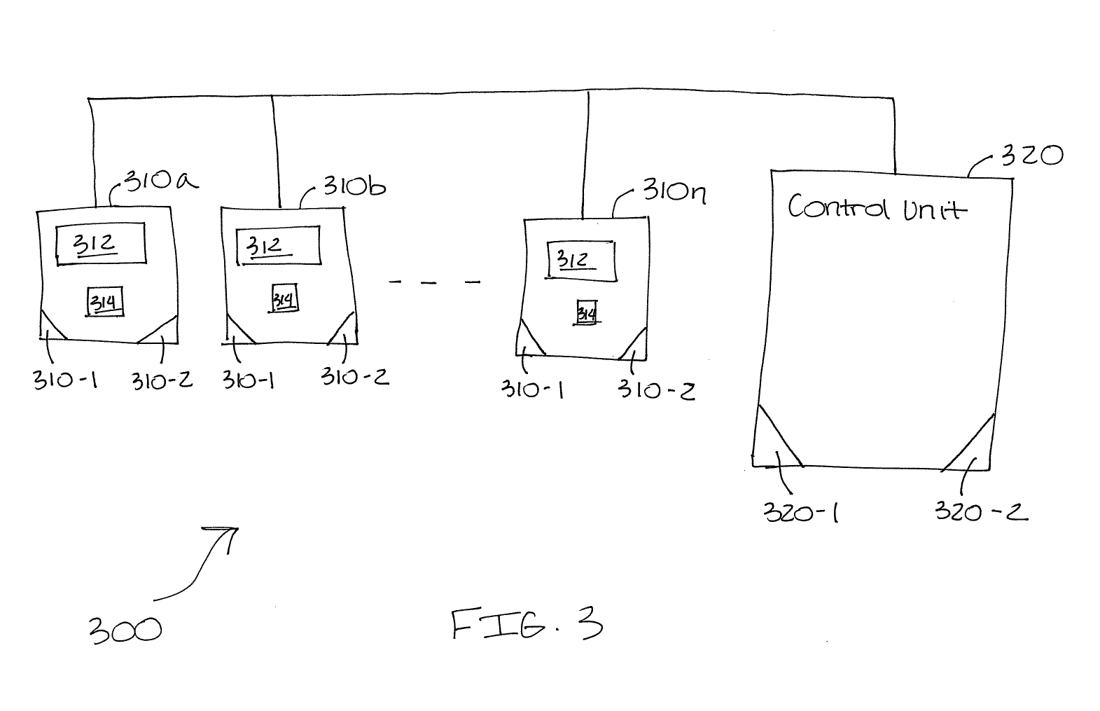

The methods of FIG. 1, FIG. 2, and others in accordance with the present invention can be implemented with the system 300 shown in FIG. 3. The system 300 can be an access control system or a time and attendance system. However, the system 300 is not so limited and can be any type of system that employs terminals or user interfaces and as would be known by those of ordinary skill in the art. As seen in FIG. 3, the system 300 can include a plurality of terminals/user interfaces 310a, 310b . . . 310n that are in wired or wireless communication with a control unit 320.

The control unit 320 can be implemented with one or more programmable processors 320-1 and executable control software 320-2 as would be understood by those of skill in the art. The executable control software 320-2 can be stored on a transitory or non-transitory local computer readable medium.

Each of the plurality of terminals 310a, 310b . . . 310n can also include one or more programmable processors 310-1 and executable control software 310-2. The executable control software 310-2 can be stored on a transitory or non-transitory local computer readable medium.

Each of the plurality of terminals 310a, 310b . . . 310n can also include an output display 312 and an input device 314. For example, the output display 312 can include a terminal display and, in some embodiments can be a multi-dimensional graphical user interface. The input device 314 can include a reader, keypad, scanner, magnetic swipe, and/or any other type of input device as would be known to those of skill in the art. In some embodiments, one or more of the terminals 310a, 310b . . . 310c can also include one or some of a microphone, speaker, photo camera, or video camera.

In embodiments of the present invention that include a photo camera or video camera, a terminal 310a, 310b . . . 310n can also include a sensor to detect when environmental light is low and/or an alarm to signal when environmental light is low. In some embodiments, when environmental light is low, the terminal 310a, 310b . . . 310n can switch on an associated or external lamp to provide improved environmental light.

The terminal display 312 can be a graphic display and/or a color display. In some embodiments, the terminal display 312 can include navigator arrows (e.g., four arrows), enter and cancel icons, and/or a keyboard with icons representing ten digits (e.g., 1-10) for entering, for example, a PIN code. In some embodiments, the terminal display 312 can be a touch screen that is responsive to a user's touch.

According to the present invention, the terminal display 312 can be switched on, off, or to a sleep mode, and the backlighting can be decreased to decrease the amount of power consumption of the terminal device 310a, 310b . . . 310n. In some embodiments of the present invention, an environmental light sensor can regulate the backlight of the terminal display 312.

In some embodiments of the present invention, after a predetermined period of inactivity, the terminal display 312 can be switched to an off or sleep mode. Then, when a card is presented to the reader 314 or other sensor of the terminal 310a, 310b . . . 310n, the terminal display 312 can be switched to an on mode. In some embodiments, the terminal display 312 can be switched to an on mode when a card is detected at a distance as far as approximately 1 meter from the terminal 310a, 310b . . . 310n.

The reader 314 can be any kind of reader as would be known by those of skill in the art and as would be compatible with cards held by users of the associated system 300. For example, the reader 314 can be an RF reader, a magnetic swipe reader, or a biometric fingerprint reader.

Each of the plurality of terminals 310a, 310b . . . 310n can be mounted in fixed position. For example, a terminal 310a, 310b . . . 310n can be mounted on a wall, door, turnstile, or any other location as would be desired by one of skill in the art. In some embodiments of the present invention, a terminal 310a, 310b . . . 310n can be mounted with an adjustable mount, for example, a back swivel support, so that the slope of the terminal 310a, 310b . . . 310n can be adjusted. In some embodiments of the present invention, the terminal 310a, 310b . . . 310n can be mounted with a tamper resistant mount.

The terminal 310a, 310b . . . 310n can be in wired or wireless communication with the control unit 320. When in wired communication, all wires extending from the terminal 310a, 310b . . . 310n can extend out of a back side thereof so as to be hidden from the user.

Terminals 310a, 310b . . . 310n in accordance with the present invention can have low power consumption. In some embodiments of the present invention, a terminal 310a, 310b . . . 310n can be powered with, for example, an internal or external power supply or via an Ethernet cable.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

1. A method comprising:
detecting a card within range of a terminal reader;
receiving information stored on the card from the card;
determining if the information stored on the card requires customization of any of a plurality of terminal characteristics; and
when the information stored on the card requires customization of any of the plurality of terminal characteristics, changing at least one of the plurality of terminal characteristics using the information stored on the card,
wherein changing the at least one of the plurality of terminal characteristics includes changing the at least one of the plurality of terminal characteristics for a predetermined period of time after a last user interaction.

2. The method of claim 1 wherein the plurality of terminal characteristics includes at least one of color of a terminal display, contrast of the terminal display, language of the terminal display, size and text of the terminal display, volume of terminal tunes, types of terminal tunes, oral transmission of text shown on the terminal display, emanation of visual cues based on text shown on the terminal display, reduction of operative procedures, extension of time-out periods, operation of particular commands, information relevant to a holder of the card.

3. The method of claim 1 wherein the received information stored on the card includes a user preference for at least one of the plurality of terminal characteristics.

4. The method of claim 3 further comprising setting each of the plurality of terminal characteristics to a default mode.

5. The method of claim 4 wherein changing the at least one of the plurality of terminal characteristics includes changing the at least one of the plurality of terminal characteristics from the default mode to a user preference mode.

6. The method of claim 5 further comprising maintaining, in the default mode, each of the plurality of terminal characteristics that is not the at least one of the plurality of terminal characteristics.

7. The method of claim 5 further comprising saving the user preference mode as the default mode.

8. (canceled)

9. A method comprising:
receiving an explicit request to customize a terminal;
receiving user input for customizing at least one of a plurality of terminal characteristics;
changing at least one of the plurality of terminal characteristics using the user input;
detecting a card within range of a terminal reader; and
associating the card with the changed at least one of the plurality of terminal characteristics,
wherein changing the at least one of the plurality of terminal characteristics includes changing the at least one of the plurality of terminal characteristics for a predetermined period of time after a last user interaction.

10. The method of claim 9 further comprising transmitting, to a plurality of other terminals, a message regarding the card being associated with the changed at least one of the plurality of terminal characteristics.

11. The method of claim 9 wherein the plurality of terminal characteristics includes at least one of color of a terminal display, contrast of the terminal display, language of the terminal display, size and text of the terminal display, volume of terminal tunes, types of terminal tunes, oral transmission of text shown on the terminal display, emanation of visual cues based on text shown on the terminal display, reduction of operative procedures, extension of time-out periods, operation of particular commands, information relevant to a holder of the card.

12. The method of claim 9 wherein the user input includes a user preference for at least one of the plurality of terminal characteristics.

13. The method of claim 12 further comprising setting each of the plurality of terminal characteristics to a default mode.

14. The method of claim 13 wherein changing the at least one of the plurality of terminal characteristics includes changing the at least one of the plurality of terminal characteristics from the default mode to a user preference mode.

15. The method of claim 14 further comprising maintaining, in the default mode, each of the plurality of terminal characteristics that is not the at least one of the plurality of terminal characteristics.

16. The method of claim 14 further comprising saving the user preference mode as the default mode.

17. (canceled)

18. An apparatus comprising:
an input device for receiving user information from a cardholder or from a card;
an output display for showing terminal information or system information to the cardholder; and
a programmable processor and executable control software stored on a non-transitory computer readable medium for updating at least one characteristic of the output display based on the user information received from the cardholder or from the card and for displaying the output display with the updated at least one characteristic for a predetermined period of time after a last cardholder interaction with the output display.

19. The apparatus of claim 18 wherein the user information from the cardholder includes at least an explicit request to customize the output display or a user preference for customizing the output display, and wherein the user information from the card includes a user preference for customizing the output display.

20. The apparatus of claim 18 further comprising at least one of a microphone, speaker, phone camera, or video camera.

21. The method of claim 1 wherein the predetermined period of time after the last user interaction ends upon detecting a second card within range of the terminal reader.

22. The method of claim 9 wherein the predetermined period of time after the last user interaction ends upon detecting a second card within range of the terminal reader.
